(19) United States
(12) Patent Application Publication
(10) Pub. No.: US 2017/0322689 A1
(43) Pub. Date: Nov. 9, 2017

(54) METHOD AND DEVICE FOR MULTI-TASK MANAGEMENT, AND COMPUTER-READABLE MEDIUM

(71) Applicant: Beijing Xiaomi Mobile Software Co., Ltd., Beijing (CN)

(72) Inventors: Yin ZHU, Beijing (CN); Qiaozhuo CHEN, Beijing (CN); Xiaochuang LU, Beijing (CN); Fan BU, Beijing (CN); Zhenzhou LU, Beijing (CN); Chengxing GAO, Beijing (CN)

(73) Assignee: Beijing Xiaomi Mobile Software Co., Ltd., Beijing (CN)

(21) Appl. No.: 15/487,780

(22) Filed: Apr. 14, 2017

(30) Foreign Application Priority Data
May 5, 2016 (CN) 201610294117.4

(51) Int. Cl. G06F 3/0483; G06F 9/48; G06F 3/0484

(52) U.S. Cl. CPC G06F 3/0483; G06F 3/04842; G06F 9/485

(57) ABSTRACT

Disclosed are methods and devices for multi-task management by a computing device. One method for multi-task management may include: receiving an operation signal for triggering display of a multi-task management interface; acquiring every running application on the computing device; acquiring, for each of the running applications, cached cache pages related to the application; displaying collections of previews for the running applications in the multi-task management interface, a collection of previews for an application being used to aggregate and display cache pages related to the application; and acquiring a selected cache page, controlling an application corresponding to the selected cache page to run in the foreground, and controlling the application to initially display the selected cache page.

### CROSS-REFERENCE TO RELATED APPLICATION

This application is based on and claims priority to Chinese Patent Application No. 201610294117.4 filed on May 5, 2016, which is incorporated herein by reference in its entirety.

### FIELD

The present disclosure relates to the field of computing devices capable of running multiple applications, and more particularly to methods and devices for multi-task management.

### BACKGROUND

Currently, computing devices such as smart phones, tablet computers, laptops, and the like are widely used for their operational convenience and functional diversity. These devices often allow users to run multiple applications concurrently, with one application in the foreground, and one or more other applications in the background.

With certain computing devices, users may be able to operate a multi-task management controller to invoke a multi-task management interface. Running applications are then displayed in the multi-task management interface, and every application displays the last opened page as a preview page. If one of the applications is triggered (selected), then the computing device switches the triggered application to the foreground, and controls the application to display the page that was previewed in the multi-task management interface. The triggered application, however, might itself have multiple pages within it, and the previewed page might not be page the user wishes to access. If that is the case, a user would then need to take the additional steps of switching through (searching) the pages by some associated operations to view other pages of the application, and selecting the desired page. This adds complexity to the operation, which involves extra time and effort for the user.

### SUMMARY

Methods and devices for multi-task management are provided in the present disclosure. The technical solutions include the following:

According to a first aspect of the present disclosure, a method for multi-task management is provided, the method comprising: receiving an operation signal (e.g., a command, instruction, etc.) for triggering the display of a multi-task management interface; acquiring every application (or a subset thereof) running on the computing device (e.g., software applications running in the background); acquiring, for each of the running applications, cached cache pages related to the application; displaying collections of previews for the running applications via the multi-task management interface, a collection of previews for an application being used to aggregate and display cache pages related to the application; and acquiring a selected cache page, controlling an application corresponding to the selected cache page to run in the foreground, and controlling the application to initially display the selected cache page.

According to a second aspect of the present disclosure, a computing device with multi-task management is provided, the device comprising: a first receiving module configured to receive an operation signal for triggering the display of a multi-task management interface; a first acquiring module configured to acquire every running application (or a subset thereof) on the computing device; a second acquiring module configured to acquire, for each of the running applications acquired, cached cache pages related to the application; a displaying module configured to display collections of previews for the running applications in the multi-task management interface, a collection of previews for an application being used to aggregate and display cache pages related to the application; and a first controlling module configured to acquire a selected cache page, control an application corresponding to the selected cache page to run in the foreground, and control the application to initially display the selected cache page.

According to a third aspect of the present disclosure, there is provided a non-transitory computer-readable storage medium having stored therein instructions that, when executed by a processor of a computing device, causes the device to perform a method for multi-task management, the method comprising: receiving an operation signal for triggering the display of a multi-task management interface; acquiring every running application (or a subset thereof) on the computing device; acquiring, for each of the running applications, cached cache pages related to the application; displaying collections of previews for the running applications in the multi-task management interface, a collection of previews for an application being used to aggregate and display cache pages related to the application; and acquiring a selected cache page, controlling an application corresponding to the selected cache page to run in the foreground, and controlling the application to initially display the selected cache page.

It is to be understood that the forgoing general description and the following detailed description are exemplary only, and are not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow chart of a method for multi-task management illustrated according to an exemplary embodiment;

FIG. 2A is a flow chart of a method for multi-task management illustrated according to another exemplary embodiment;

FIG. 2B is a schematic diagram of triggering the display of a multi-task management interface illustrated according to an exemplary embodiment;

FIG. 2C is a schematic diagram of a presenting (presentation) of a collection of previews for applications in a multi-task management interface illustrated according to an exemplary embodiment;

FIG. 2D is a schematic diagram of another presenting of a collection of previews for applications in a multi-task management interface illustrated according to an exemplary embodiment;

FIG. 2E is a schematic diagram of presenting of every cache page in an extension way in a collection of previews illustrated according to an exemplary embodiment;

FIG. 2F is a schematic diagram of another presenting of every cache page in an extension way in a collection of previews illustrated according to an exemplary embodiment;

FIG. 2G is a flow chart of a method for switching of which cache page is presented on the top layer of a collection of previews illustrated according to an exemplary embodiment;

FIG. 2H is a schematic diagram for switching of which cache page is presented on the top layer of a collection of previews illustrated according to an exemplary embodiment;

FIG. 2I is a schematic diagram for another switching of which cache page is presented on the top layer of a collection of previews illustrated according to an exemplary embodiment;

FIG. 3 is a block diagram of a device for multi-task management illustrated according to an exemplary embodiment;

FIG. 4 is a block diagram of a device for multi-task management illustrated according to another exemplary embodiment;

FIG. 5 is a block diagram of a device for managing multi-task illustrated according to an exemplary embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of example embodiments of the present disclosure.

### DETAILED DESCRIPTION

Exemplary embodiments will now be illustrated in detail, examples of which are illustrated in the accompanying drawings. When the following description refers to the accompanying drawings, the same numbers in different drawings represent the same or similar elements, unless otherwise described. The implementations described in the following exemplary embodiments do not represent all of the implementations consistent with the present disclosure. Instead, they are only examples of devices and methods consistent with aspects of the present disclosure as recited in the appended claims.

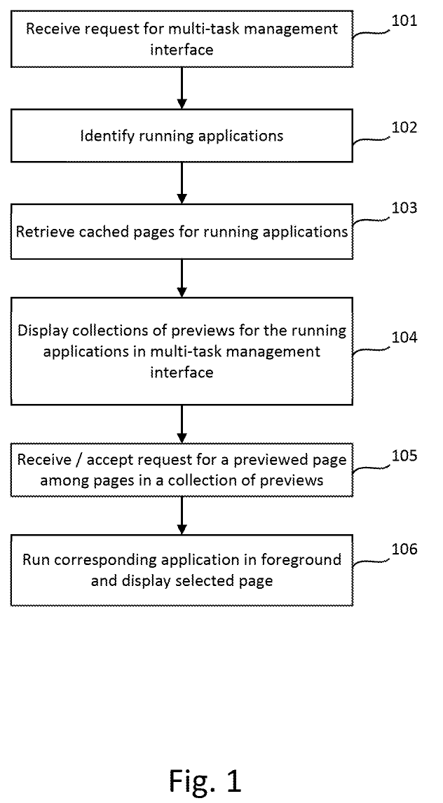

FIG. 1 is a flow chart of a method for multi-task management illustrated according to an exemplary embodiment. This multi-task management method may be applied in, for example, a computing device with a touch screen, and may comprise the following exemplary steps.

In step 101, an operation signal (arising from, for example, a request by a user) for triggering (initiating) the display of a multi-task management interface may be received. For example, a user of a computing device may have multiple software applications running concurrently, with one in the foreground and others in the background. This may be because the user launched a second, third, etc., application without exiting, terminating, or “shutting down” an already-running application. A new application, when first launched, may be placed in the foreground by the computing device, with its pages displayed “in front” of the pages of other applications, so that the user may actively engage with the application in the foreground. Previously-run applications may be switched to the background, with its pages no longer displayed/viewable but instead hidden or moved “behind” the pages of the application in the foreground. The pages of background applications may be “cached” in memory so that they are more readily accessible. (Pages not currently displayed, such as those of background applications, are cached, and will be interchangeably referred to as “cache pages,” “cached pages,” or “cached cache pages.”) Applications in the background may continue executing processes, or they may be in “dormant” state during which current or new processes are paused or canceled, but in either case, their pages are not displayed (or are otherwise de-emphasized relative to the pages of the foreground application). Because applications in the background were not terminated, they do not need to be re-launched, and a user may return/switch to a “background” application using a multi-task (multi-application) management interface.

In step 102, every running application (or, in alternative implementations, a subset of running applications, such as all applications of a given type or function) on the computing device may be identified/acquired. “Running applications” that are identified/acquired may be limited to software applications launched by a user, and not software applications (services, processes, etc.) launched by the operating system. Because each running application may have had multiple pages viewed, opened, or accessed by the user, this step may include, in various implementations, identifying the cached pages corresponding with each running application (e.g., determining which applications have multiple cached pages, the number of cached pages for each application, etc.). In the case of an internet browser, for example, cached pages may correspond with different webpages (which might be organized in multiple “tabs”) being accessed. In the case of document editing software (such as a word processor), cached pages may correspond with, for example, “open” documents (i.e., documents not closed out) that a user might have been viewing and/or editing. In the case of a photograph or video viewer/editor, the cached pages may correspond to, for example, photographs or videos being viewed or edited by the user (or otherwise opened or accessed).

In step 103, for each running application, cached cache pages related to the application may be acquired/retrieved. Once retrieved, cached pages may be organized/grouped/aggregated into collections of previews, each collection of previews corresponding with one application (or, in various exemplary implementations, a grouping of applications).

In step 104, the collections of previews for one or more of the running applications may be displayed in the multi-task management interface. That is, each collection of previews for an application may be used to aggregate and display cache pages related to the application.

In step 105, a user may make a selection of one of the cached pages in one of the collections of previews. The selection input may be received via touch screen, keyboard, mouse, voice command, gesture recognition, or any other input means available to the computing device and user.

In step 106, the selected cache page may be acquired/retrieved for display, and the application corresponding to the selected cache page may be controlled to run in (i.e., switched to) the foreground. The application may be controlled to initially display the selected cache page.

As above described, a method for multi-task management is provided in embodiments of the present disclosure, by receiving an operation signal for triggering the display of a multi-task management interface, and for each of the running applications, cached cache pages related to the application may be acquired. Collections of previews for the running applications may be displayed in the multi-task management interface, and a collection of previews for an application may be used to aggregate and display cache pages related to the application. A selected cache page may be acquired, an application corresponding to the selected cache page may be controlled to run in the foreground, and the application may be controlled to initially display the selected cache page. As a user may select a cache page from collections of previews provided in a displayed multi-task management interface by inputting a predetermined operation signal for triggering the multi-task management interface, and the computing device may control an application corresponding to the selected cache page to run in the foreground and control the application to initially display the selected cache page, operations for switching to a target page of the application may be simplified. The technical problem, that operations for switching to a target page of the application in related technology are complex, may be solved and the purpose of simplifying operations for switching to a target page of the application may be achieved.

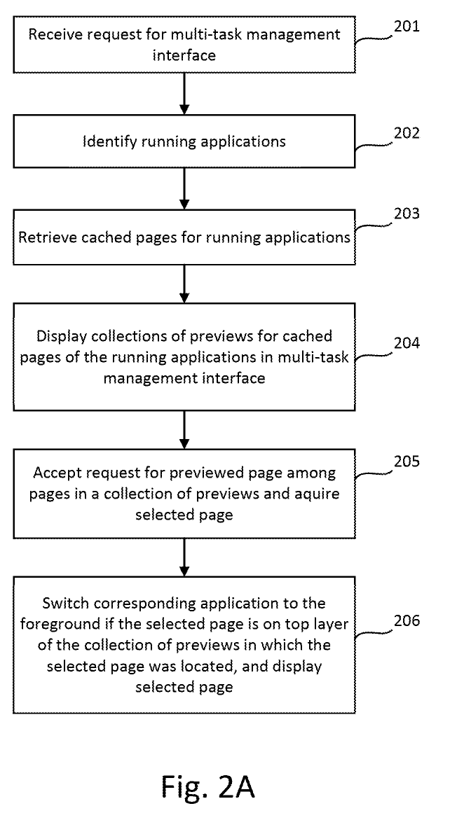

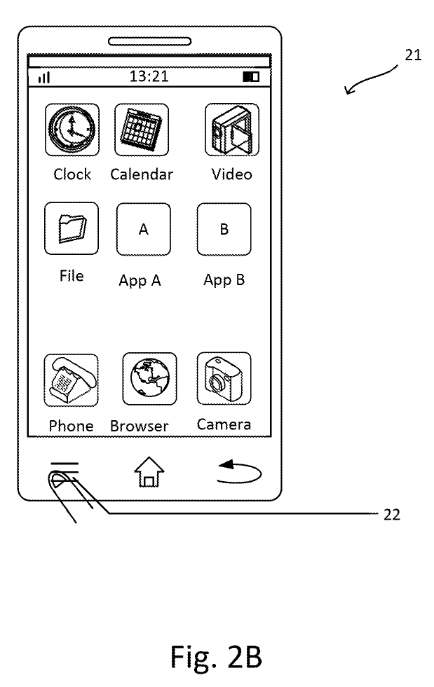

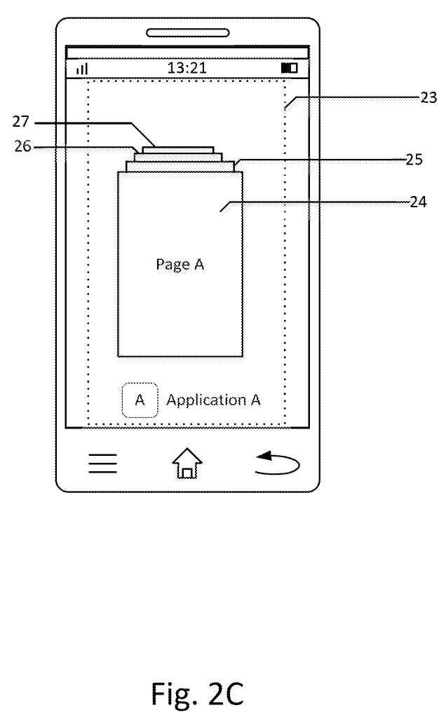

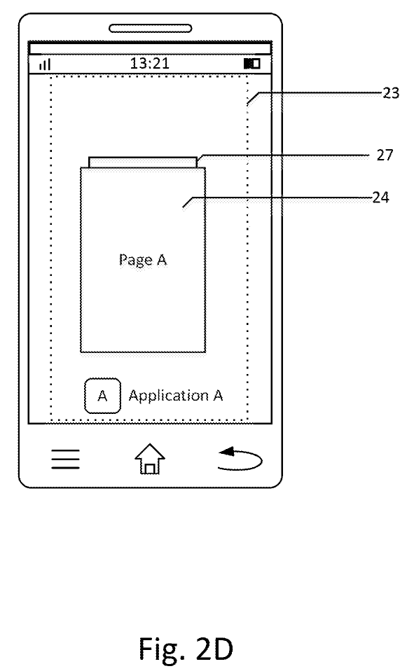

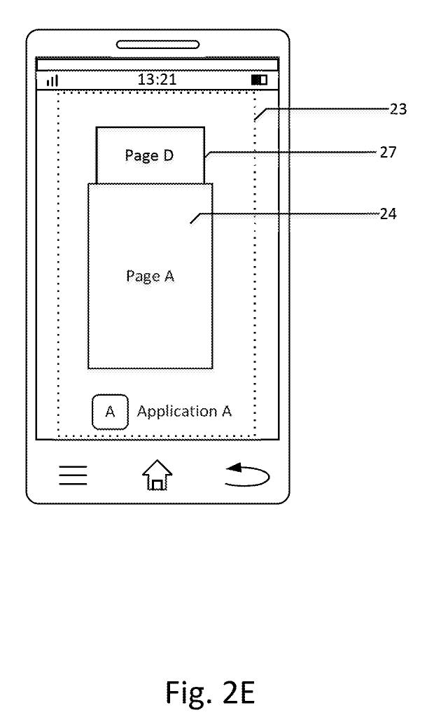

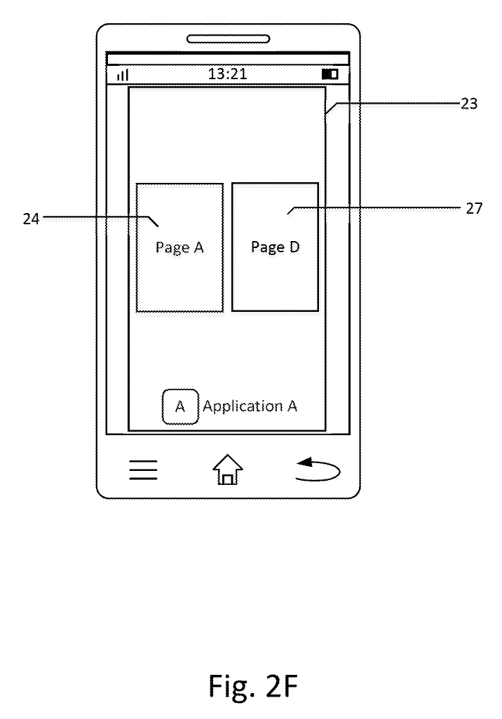

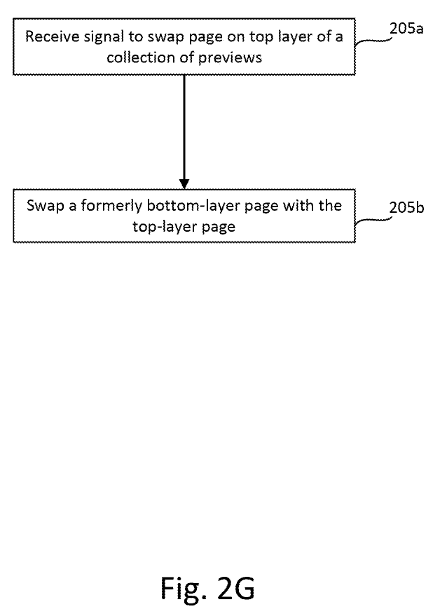

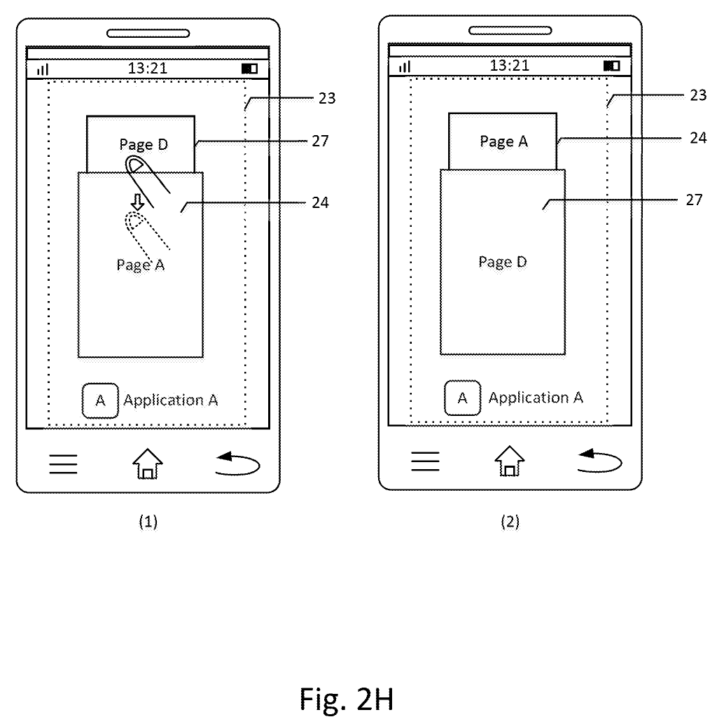

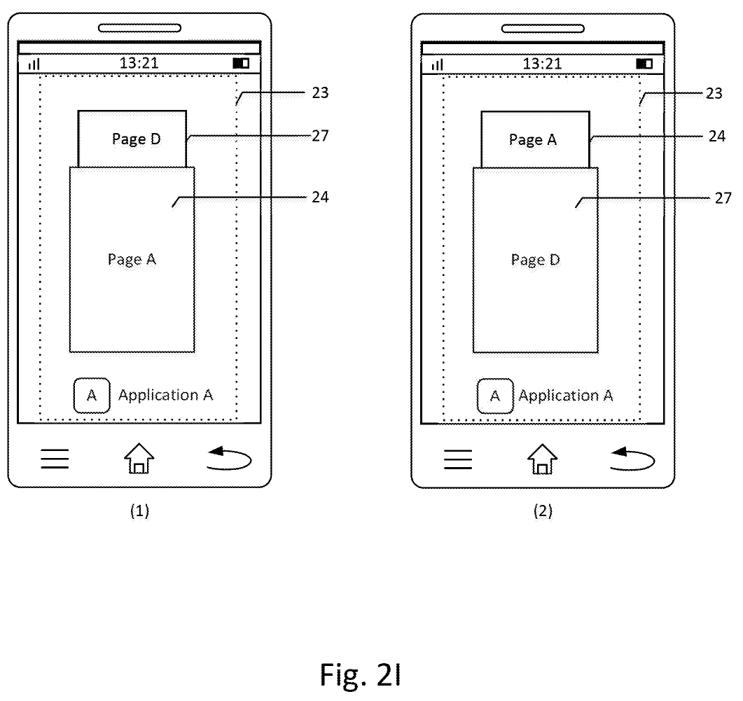

FIG. 2A is a flow chart of a method for multi-task management illustrated according to another exemplary embodiment. This multi-task management method may be applied in computing devices with a touch screen, and may comprise the following steps.

In step 201, an operation signal (resulting from, for example, a user input/request) for triggering (initiating) the display of a multi-task management interface may be received.

The operation signal discussed here may be generated when, for example, a physical or virtual button on the computing device is depressed or otherwise triggered. In certain implementations, the operation signal may also be a gesture inputted by the user on the touch screen of the computing device, or may be generated when the computing is shaken in a predetermined trajectory. The operation signal is not limited in the present embodiment, and its specific implementation may be determined according to, for example, the computing device hardware, software environment, or other factors.

In various embodiments, the operation signal may be generated when some physical button on the computing device is triggered, as depicted in FIG. 2B. A computing device 21 may comprise a multi-task button 22 which may be used to trigger the display of a multi-task management interface. When the user depresses or touches the multi-task button 22, an operation signal for triggering the display of a multi-task management interface may be generated.

The multi-task management interface may be used, in exemplary implementations, to display every running application. In the present embodiment, when every application is displayed in the multi-task management interface, the application may be displayed in the form of a corresponding collection of preview pages, such that the collection of previews for the application may be an aggregate of cache pages associated with this application.

In step 202, it may be determined which applications are running on the computing device. Once running applications have been identified, in step 203, for each running application, cached cache pages related to the application may be acquired (retrieved from memory).

The cache pages associated with an application may be pages that are, for example, opened, accessed, displayed, or created using the application after the application is started (launched). For example, after an application A is started, the user may open page A, page B, page C, and page D successively in the application A. Accordingly, the computing device may cache page A, page B, page C, and page D respectively, and consider these pages as cache pages associated with this application. For example, page A may be cached when the user moves to page B, page B may be cached when the user moves to page C, page C may be cached when the user moves to page D, and page D may be cached when the user switches to a different application.

Thus, after the operation signal for triggering the display of the multi-task management interface is received, for every running application, cache pages associated with this application may be acquired directly.

In step 204, a collection of previews for each running application that has more than one cached page may be displayed in the multi-task management interface. The collection of previews for an application may be used as a method of aggregating and displaying cache pages in association with the application.

Alternatively, this step may be realized by the following two possible implementations:

In a first exemplary implementation, for a collection of previews for each application, cache pages associated with the application may be presented (displayed) in a superposition manner (i.e., with pages superimposed on each other). For example, all (or most) of a “top” page may be fully (or mostly) visible, while remaining pages may have a portion visible and a portion covered by one or more overlapping pages. Consequently, at least part of the area of any cache page in each collection of previews is not covered by other cache pages in the collection of previews.

The superimposed (stacked) pages may be sequenced according to a first predetermined order. The first predetermined order may be, for example, the sequential order in which the cache pages were opened, accessed, displayed, or created. Preferably, the first predetermined order may be determined according to the frequency with which cache pages were opened, accessed, or displayed (from high to low, for example). This may be implemented in other ways in alternative configurations, and the specific implementation may be tailored to suit needs.

When presenting cache pages related to the application in a superposition manner, the first cache page according to the first predetermined order may be presented on a top or first layer, the second cache page according to the first predetermined order may be presented on the second layer, and so on. A predetermined order based on time, for example, may position the most recent page on top, and the oldest (which may be, for example, the first page opened by the application) at the bottom. Similarly, a predetermined ordering based on frequency may, for example, may position the most accessed page on top, and the least accessed page on the bottom.

Taking the multi-task management interface presenting a collection of previews for an application A as an example, as depicted in FIG. 2C, cache pages associated with the application A may be page A, page B, page C, and page D. When the preview interface 23 of the application A presents a collection of previews, the page A 24, page B 25, page C 26, and page D 27 may be presented in a superposition manner according to the sequence in which the cache pages were opened, and at least part of the area of any cache page in the collection of previews is not covered by other cache pages in the collection of previews.

In a second exemplary implementation of a collection of previews for every application, a predetermined number of cache pages related to the application may be presented in a superposition manner according to a second predetermined order, wherein at least part of the area of any cache page in each collection of previews is not covered by other cache pages in the collection of previews.

Generally, the second predetermined order may be the sequential order that the cache pages were opened. Preferably, the second predetermined order may also be the order of the frequency that the cache pages were opened (from high to low, for example). This may be implemented in other ways in alternative configurations, and the specific implementation may be tailored to suit needs.

When presenting cache pages related to the application in a superposition manner, the first cache page according to the second predetermined order may be presented on the top layer, the second cache page according to the second predetermined order may be presented on the second layer, and so on.

The predetermined number of cache pages displayed in the collection of previews may be set by the user, or may be a system default. The number may be a preset number (for example, three pages), or as a percentage of pages (for example, half of the cached pages). If a percentage is used, the collection of previews may be useful for visually imparting information on which applications were relatively more (or less) actively used, as an application with five pages displayed could be mentally noted as having been used more heavily than an application with two pages displayed. If the system default predetermined number of cache pages presented in the predetermined collection of applications is two, for example, then cache pages associated with the application may be ordered according to the second predetermined order, and the top two cache pages may be presented in the collection of previews in a superposition manner according to the second predetermined order.

For example, it may be determined that cache pages associated with application A are page A, page B, page C, and page D, and the system may present only two cache pages in a collection of previews. The two displayed pages may be ordered according to the cache page open frequency (from high to low, for example), wherein the open frequency of page A may be the highest, followed by page D. As shown in FIG. 2D, page A 24 and page D 27 may be presented in the collection of previews for application A in a superposition manner, with page A 24 being presented on the top layer of the collection of previews. As shown, page A 24 is not covered by page D 27, and a portion of the area of page D 27 is not covered by page A 24.

Alternatively, in order to allow the user to better browse every cache page in a collection of previews, when it is detected that a collection of previews is selected, every cache page in this collection of previews may be presented in an extension way.

There may be many ways for implementing presentation in extension ways. For example, cache pages in the collection of previews may be tiled in the preview interface; moreover, the cache pages presented in a superposition manner may be stretched vertically for presenting, so as to reduce the covered area of cache pages that are not on the top layer.

For example, still referring to FIG. 2D, which is a schematic diagram in which page A 24 and page D 27 are presented in the collection of previews for application A in a superposition manner, when the computing device detects that this collection of previews is selected, then the cache pages presented in a superposition manner may be stretched vertically (e.g., page D 27 may be moved or otherwise positioned such that it extends farther above page A 24) for presenting, as shown in FIG. 2E.

Referring to FIG. 2F, in alternative configurations, when the computing device detects that the collection of previews of FIG. 2D is selected, then page A 24 and page D 27 may be tiled in the preview interface 23. This may, for example, position previewed pages adjacent to each other.

In step 205, a request for (selection of) a previewed page may be received, and the selected cache page may be acquired/retrieved. In step 206, if the selected cache page is on a top layer of the collection of previews in which the selected cache page locates, an application corresponding to the selected cache page may be controlled to run in the foreground, and the application may be controlled to initially display the selected cache page.

For example, still referring to FIG. 2E, the user may click the top layer cache page A of the collection of previews for the application A, and then the application A may be controlled to be displayed in the foreground and to display the page A.

It should be noted that, in the present embodiment, when collections of previews for the every running application are displayed in the multi-task management interface, every collection of previews may be displayed horizontally in a single row in the multi-task management interface according to a third predetermined order. Generally, a display screen may only present a limited number of collections of previews, and the user may trigger the presentation of more collections of previews by inputting a predetermined gesture if the user wants to acquire more collections of previews. For example, the running applications may include application A and application B, still referring to the collection of previews presenting the application A in FIG. 2B. If the user wants to view collections of previews for more applications, the user may trigger the display of the collection of previews for the application B by inputting a right slide gesture.

However, examples in the present embodiment do not limit the way the multi-task management interface displays collections of previews for every running application. In practical applications, when every collection of previews is displayed in the multi-task management interface, every collection of previews for the applications may be also displayed horizontally in dual rows according to the third predetermined order. The third predetermined order may be the order the applications were opened recently, or the order of open frequency of applications (from high to low).

As above described, a method for multi-task management is provided in embodiments of the present disclosure, by receiving an operation signal for triggering the display of a multi-task management interface, for each of the running applications, cached cache pages related to the application may be acquired. Collections of previews for the running applications may be displayed in the multi-task management interface, and a collection of previews for an application may be used to aggregate and display cache pages related to the application. A selected cache page may be acquired, an application corresponding to the selected cache page may be controlled to run in the foreground, and the application may be controlled to initially display the selected cache page. As a user may select a cache page from collections of previews provided in a displayed multi-task management interface by inputting a predetermined operation signal for triggering the multi-task management interface, and the computing device may control an application corresponding to the selected cache page to run in the foreground and control the application to initially display the selected cache page, operations for switching to a target page of the application may be simplified. The technical problem, that operations for switching to a target page of the application in related technology are complex, may be solved, and the purpose of simplifying operations for switching to a target page of the application may be achieved.

Moreover, after acquiring a selected cache page, controlling the selected cache page to be presented on a top layer of a collection of previews in which the selected cache page locates, if the selected cache page is not on the top layer of the collection of previews in which the selected cache page locates, enables the user to to switch the cache page presented on the top layer of the collection of previews. That is, the user may switch other caches page that are not on the top layer of the collection of previews to be presented on the top layer of the collection of previews.

Moreover, after an application is started (launched), by caching pages that the application opens during this startup, the pages may be considered as cache pages related to the application. By, after an application is started, caching pages that the application opens during this startup, these pages may be considered as cache pages related to the application, such that cache pages related to every running application may be acquired directly when the multi-task management interface is evoked subsequently to display.

Moreover, presenting every cache page in one collection of previews in an extension way when detecting that the collection of previews is selected, to enable the user to be able to browse every cache page contained in the collection of previews.

Alternatively, when cache pages in the collection of previews are presented in the multi-task management interface, the user may also switch the cache page presented on the top layer of the collection of previews. Specifically, the switching of the cache page presented on the top layer of the collection of previews may be implemented by, for example, the several sub-steps shown in FIG. 2G.

In step 205a, a switch signal triggered for a designated collection of previews may be acquired, and the switch signal may be used to indicate to switch a cache page presented on a top layer. That is, a signal may be received to swap the page on the top layer of a collection of previews.

The switch signal discussed here may generally be gestures inputted by the user on the touch screen of the computing device. For example, the switch signal may be an up-slide operation gesture, or a down-slide operation gesture. This is not limited in the present embodiment, and any other suitable input may be used.

In step 205b, a first cache page presented on the top layer of the designated collection of previews may be controlled to switch to be presented on a bottom layer of the designated collection of previews, and a second cache page behind the first cache page may be switched to be presented on the top layer of the designated collection of previews in order. That is, the bottom-layer page may swap places with the top-layer page.

The first cache page discussed here may generally be the cache page presented on the top layer of the collection of previews, and the second cache page may be the cache page presented on the next layer of the first cache page (i.e., the second layer of the collection of previews), and so on. The designated collection of previews discussed here may generally be designated by the user, i.e., the collection of previews selected by the user may be the designated collection, and the top layer cache page of the collection of previews designated by the user may need to be switched.

For example, as shown on the left side of FIG. 2H, the user may input a down-slide gesture for switching the cache page presented on the top layer in the collection of previews for application A. Accordingly, the computing device may receive a switch signal triggered for the collection of previews for application A, as shown on the right side of FIG. 2H. The first cache page (page A 24) of this collection of previews may be controlled to be presented on the bottom layer of this collection of previews, and the second cache page (page D 27) ordered behind the first cache page may be switched to be presented on the top layer of this designated collection of previews. The “back” page to be moved forward or to the “front” may be selected by, for example, holding the finger in position over an uncovered portion of the back page, double-tapping the back page, applying slightly greater pressure over the area of the screen with the back page, etc.

Alternatively, after a selected cache page is acquired, the selected cache page may be controlled to be presented on the top layer of a collection of previews in which the selected cache page locates if the selected cache page is not on the top layer of the collection of previews in which the selected cache page locates

For example, as shown on the left in FIG. 2I, the page A 24 and page D 27 may be presented in an extension way in the collection of previews for the application A, while the page A 24 may be on the top layer of this collection of previews, and the page D 27 may be on the bottom layer of this collection of previews. When the user clicks the page D 27, as shown on the right in FIG. 2I, the computing device may control the page D 27 to be presented on the top layer of this collection of previews. The swap may be initiated by a simple click or “selection” without any gesture in a particular direction.

Alternatively, when the application stops running, the cached cache pages associated with this application may be cleared.

Alternatively, when the application is a browser, webpage tabs opened in the browser application may also be aggregated into collections of previews for this browser application.

The following are device embodiments of the present disclosure, which may be used to perform method embodiments of the present disclosure. Details not explicitly disclosed with respect to device embodiments of the present disclosure may be found in the discussion of method embodiments of the present disclosure.

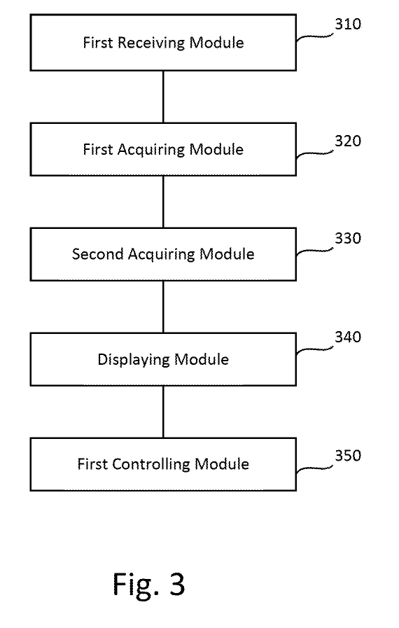

FIG. 3 is a block diagram of an exemplary device for multi-task management illustrated according to an exemplary embodiment, which may be applied in a computing device with a touch screen. This device for multi-task management may comprise: a first receiving module 310, a first acquiring module 320, a second acquiring module 330, a displaying module 340, and a first controlling module 350.

The first receiving module 310 may be configured to receive an operation signal for triggering the display of a multi-task management interface.

The first acquiring module 320 may be configured to acquire every running application on the computing device.

The second acquiring module 330 may be configured to acquire, for each of the running applications, cached cache pages related to the application.

The displaying module 340 may be configured to display collections of previews for the running applications in the multi-task management interface, and a collection of previews for an application may be used to aggregate and display cache pages related to the application.

The first controlling module 350 may be configured to acquire a selected cache page, control an application corresponding to the selected cache page to run in the foreground, and control the application to initially display the selected cache page.

As above described, a device for multi-task management is provided in embodiments of the present disclosure, by receiving an operation signal for triggering the display of a multi-task management interface, and for each of the running applications, cached cache pages related to the application may be acquired. Collections of previews for the running applications may be displayed in the multi-task management interface, and a collection of previews for an application may be used to aggregate and display cache pages related to the application. A selected cache page may be acquired, an application corresponding to the selected cache page may be controlled to run in the foreground, and the application may be controlled to initially display the selected cache page. As a user may select a cache page from collections of previews provided in a displayed multi-task management interface by inputting a predetermined operation signal for triggering the multi-task management interface, and the computing device may control an application corresponding to the selected cache page to run in the foreground and control the application to initially display the selected cache page, operations for switching to a target page of the application may be simplified. The technical problem that operations for switching to a target page of the application in related technology are complex may be solved, and the purpose of simplifying operations for switching to a target page of the application may be achieved.

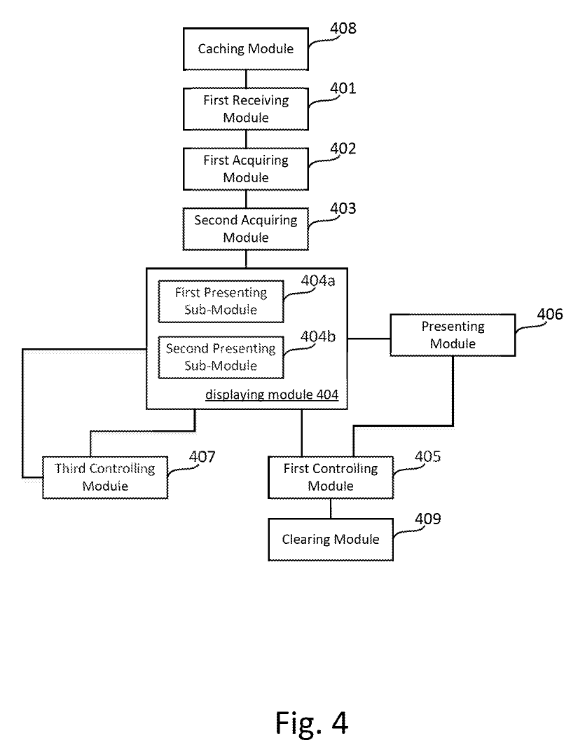

FIG. 4 is a block diagram of an exemplary device for multi-task management illustrated according to another exemplary embodiment, which may be applied in computing device with a touch screen. This device for multi-task management may comprise: a first receiving module 401, a first acquiring module 402, a second acquiring module 403, a displaying module 404, and a first controlling module 405.

The first receiving module 401 may be configured to receive an operation signal for triggering the display of a multi-task management interface.

The operation signal discussed here may be generated, for example, when a physical button on the computing device is triggered, when a gesture is inputted by the user on the touch screen of the computing device, and/or when the computing device is shaken in a predetermined manner or with a predetermined trajectory. The operation signal is not limited in the present embodiment, which may be tailored to suit particular implementations.

The multi-task management interface may be generally used to display every running application. In the present embodiment, when every application is displayed in the multi-task management interface, the application may be displayed in a form of a collection of previews for this application, and the collection of previews for this application may be used to aggregate cache pages associated with this application.

The first acquiring module 402 may be configured to acquire every running application on the computing device.

The second acquiring module 403 may be configured to acquire, for each of the running applications, cached cache pages related to the application.

The cache pages associated with the application discussed here may be acquired by, after the application is started, caching pages that the application opens during this startup. Thus, after the operation signal for triggering the display of the multi-task management interface is received, for every running application, cache pages associated with this application may be acquired directly.

The displaying module 404 may be configured to display collections of previews for the running applications in the multi-task management interface, and a collection of previews for an application may be used to aggregate and display cache pages related to the application.

It should be noted that, in the present embodiment, when collections of previews for every running application are displayed in the multi-task management interface, every collection of previews may be displayed horizontally in a single row in the multi-task management interface according to a third predetermined order. Generally, a display screen may only present a limited number of collections of previews, and the user may trigger the presentation of more collections of previews by inputting a predetermined gesture (such as sliding a finger across the screen, similar to a gesture associated with “turning the page” of a book) if the user wants to acquire more collection of previews.

However, examples in the present embodiment do not limit the way the multi-task management interface displays collections of previews for every running application. In practical applications, when every collection of previews is displayed in the multi-task management interface, every collection of previews for the applications may also be displayed horizontally in dual rows according to the third predetermined order. The third predetermined order may be the order the applications were opened recently, or the order of the open frequency of applications (from high to low, for example).

The first controlling module 405 may be configured to acquire a selected cache page, control an application corresponding to the selected cache page to run in the foreground, and control the application to initially display the selected cache page.

Alternatively, the displaying module 404 may comprise: a first presenting sub-module 404a and a second presenting sub-module 404b.

The first presenting sub-module 404a may be configured to present, for a collection of previews for each application, cache pages related to the application in a superposition manner according to a first predetermined order, wherein at least part of the area of any cache page in each collection of previews is not covered by other cache pages in the collection of previews.

Generally, the first predetermined order may be the sequential order that the cache pages were opened. Preferably, the first predetermined order may also be the order of the frequency that the cache pages were opened (from high to low). This is not limited in the present embodiment, which may be tailored to suit particular implementations.

The second presenting sub-module 404b may be configured to present, for a collection of previews for each application, a predetermined number of cache pages related to the application in a superposition manner according to a second predetermined order, wherein at least part of the area of any cache page in each collection of previews is not covered by other cache pages in the collection of previews.

Generally, the second predetermined order may be the sequential order that the cache pages were opened. Preferably, the second predetermined order may also be the order of the frequency that the cache pages were opened (from high to low). This is not limited in the present embodiment, which may be tailored to suit particular implementations. The predetermined number of cache pages displayed in the collection of previews may be set by the user, or may be a system default.

Alternatively, this device for multi-task management may also comprise:

A display/presenting module 406 that may be configured to present each cache page in one collection of previews in an extension way when detecting that the collection of previews is selected.

There may be many ways for presenting in extension ways. For example, cache pages in the collection of previews may be tiled in the preview interface for presenting; moreover, the cache pages presented in a superposition manner may be stretched vertically for presenting, so as to reduce the covered area of cache pages that are not on the top layer.

Alternatively, this device for multi-task management may also comprise:

A second receiving module that may be configured to receive a switch signal triggered for a designated collection of previews, and the switch signal may be used to indicate to switch a cache page presented on a top layer.

The switch signal discussed here may generally be, for example, gestures inputted by the user on the touch screen of the computing device. For example, the switch signal may be an up-slide operation gesture, or a down-slide operation gesture.

A second controlling module may be configured to control a first cache page presented on the top layer of the designated collection of previews to switch to be presented on a bottom layer of the designated collection of previews, and switch a second cache page behind the first cache page to be presented on the top layer of the designated collection of previews in order.

The first cache page discussed here may generally be the cache page presented on the top layer of the collection of previews, and the second cache page may be the cache page presented on the next layer of the first cache page (i.e., the second layer of the collection of previews), and so on.

Alternatively, the first controlling module 405 may also be configured to control an application corresponding to the selected cache page to run in the foreground if the selected cache page is on a top layer of the collection of previews in which the selected cache page locates.

Alternatively, this device for multi-task management may also comprise:

A third controlling module 407 that may be configured to, after acquiring a selected cache page, control the selected cache page to be presented on a top layer of a collection of previews in which the selected cache page locates if the selected cache page is not on the top layer of the collection of previews in which the selected cache page locates.

Alternatively, this device for multi-task management may also comprise:

A caching module 408 that may be configured to, after an application is started, cache pages that the application opens during this startup, and consider the pages as cache pages related to the application.

Alternatively, this device for multi-task management may also comprise:

A clearing module 409 that may be configured to clear cached cache pages related to an application when the application stops running.

As above described, a device for multi-task management is provided in embodiments of the present disclosure, by receiving an operation signal for triggering the display of a multi-task management interface, and for each of the running applications, cached cache pages related to the application may be acquired. Collections of previews for the running applications may be displayed in the multi-task management interface, and a collection of previews for an application may be used to aggregate and display cache pages related to the application. A selected cache page may be acquired, an application corresponding to the selected cache page may be controlled to run in the foreground, and the application may be controlled to initially display the selected cache page. As a user may select a cache page from collections of previews provided in a displayed multi-task management interface by inputting a predetermined operation signal for triggering the multi-task management interface, and the computing device may control an application corresponding to the selected cache page to run in the foreground and control the application to initially display the selected cache page, operations for switching to a target page of the application (and not simply a single predetermined and fixed preview page) may be simplified. The technical problem that operations for switching to a target page of the application in related technology are complex may be solved, and the purpose of simplifying operations for switching to a target page of the application may be achieved.

Moreover, by receiving a switch signal triggered for a designated collection of previews, the switch signal may be used to indicate to switch a cache page presented on a top layer. A first cache page presented on the top layer of the designated collection of previews may be controlled to switch to be presented on a bottom layer of the designated collection of previews, and a second cache page behind the first cache page may be switched to be presented on the top layer of the designated collection of previews in order; this enables the user to be able to switch the cache page presented on the top layer of the collection of previews, and browse contents of every cache page in the collection of previews.

Moreover, after acquiring a selected cache page, by controlling the selected cache page to be presented on a top layer of a collection of previews in which the selected cache page locates if the selected cache page is not on the top layer of the collection of previews in which the selected cache page locates, the user is able to switch the cache page presented on the top layer of the collection of previews; that is, the user may switch other caches page that are not on the top layer of the collection of previews to be presented on the top layer of the collection of previews.

Moreover, after an application is started, by caching pages that the application opens during this startup, the pages may be considered as cache pages related to the application. By, after an application is started, caching pages that the application opens during this startup, these pages may be considered as cache pages related to the application, such that cache pages related to every running application may be acquired directly when the multi-task management interface is evoked subsequently to display.

Moreover, by clearing cached cache pages related to an application when the application stops, the system resources may be released from the cache pages.

Moreover, presenting every cache page in one collection of previews in an extension way when detecting that the collection of previews is selected, allows the user to be able to browse every cache page contained in the collection of previews.

A device for multi-task management, which may be able to implement the method for multi-task management provided in the present disclosure, is provided in an exemplary embodiment of the present disclosure. This device for multi-task management may comprise: a processor, a memory for storing processor-executable instructions.

The processor is configured to: receive an operation signal for triggering the display of a multi-task management interface; acquire every running application on the computing device; acquire, for each of the running applications, cached cache pages related to the application; display collections of previews for the running applications in the multi-task management interface, a collection of previews for an application may be used to aggregate and display cache pages related to the application; and acquire a selected cache page, control an application corresponding to the selected cache page to run in the foreground, and control the application to initially display the selected cache page.

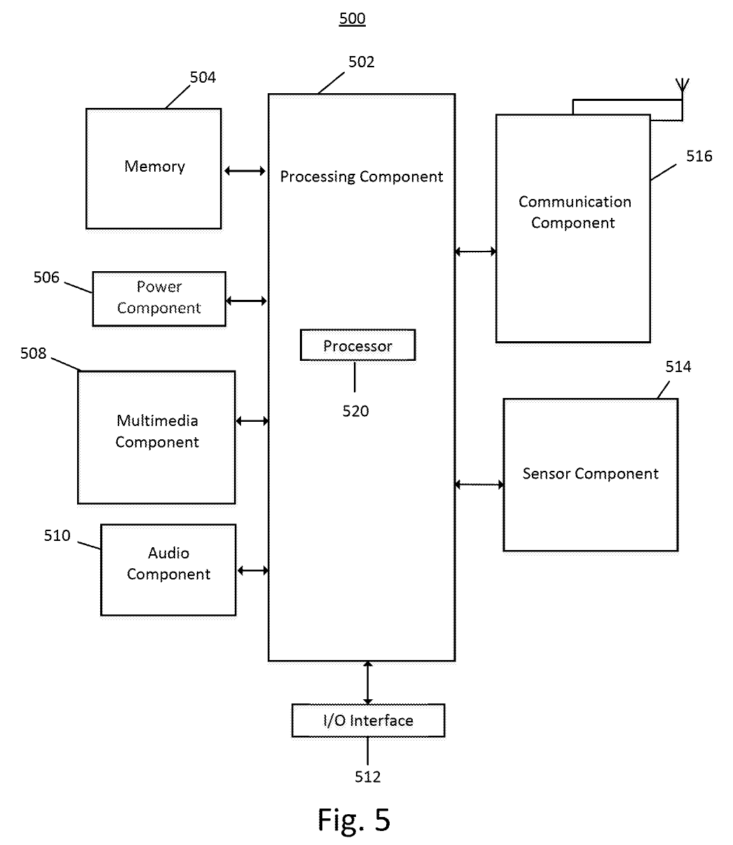

FIG. 5 is a block diagram of a device for managing multi-task illustrated according to an exemplary embodiment. For example, the device 500 may be mobile phone, computer, digital broadcast terminal, messaging device, game console, tablet device, medical device, fitness equipment, personal digital assistant, etc.

Referring to FIG. 5, the device 500 may comprise one or more of the following components: a processing component 502, a memory 504, a power component 506, a multimedia component 508, an audio component 510, an input/output (I/O) interface 512, a sensor component 514, and a communication component 516.

The processing component 502 typically controls overall operation of the device 500, such as the operations associated with display, telephone call, data communications, camera operations, and recording operations. The processing element 502 may comprise one or more processors 520 to execute instructions to perform all or part of the steps in the above described methods. Additionally, the processing component 502 may comprise one or more modules which facilitate the interaction between the processing component 502 and other components. For instance, the processing component 502 may comprise a multimedia module to facilitate the interaction between the multimedia component 508 and the processing component 502.

The memory 504 is configured to store various types of data to support the operation of the device 500. Examples of such data comprise instructions for any applications or methods operated on the device 500, contacts data, phonebook data, messages, images, videos, etc. The memory 504 may be implemented using any type of volatile or non-volatile memory devices or a combination thereof, such as a static random access memory (SRAM), an electrically erasable programmable read only memory (EEPROM), an erasable programmable read only memory (EPROM), a programmable read-only memory (PROM), a read-only memory (ROM), a magnetic memory, a flash memory, a magnetic disk, an optical disk, etc.

The power component 506 provides power to various components of the device 500. The power component 506 may comprise a power management system, one or more power sources, and any other components associated with the generation, management, and distribution of power in the device 500.

The multimedia component 508 comprises a screen providing an output interface between the device 500 and the user. In some embodiments, the screen may comprise a liquid crystal display (LCD) and a touch panel (TP). If the screen comprises the touch panel, the screen may be implemented as a touch screen to receive input signal from users. The touch panel comprises one or more touch sensors to sense touches, swipes, and gestures on the touch panel. The touch sensor may not only sense a boundary of a touch or swipe action, but also detect the duration and pressure associated with the touch or swipe operation. In some embodiments, the multimedia component 508 comprises one front camera and/or rear camera. When the device 500 is in an operation mode, such as a shooting mode or a video mode, the front camera and/or rear camera may receive external multimedia data. Every front camera and rear camera may be a fixed optical lens system or have focal length and optical zoom capability.

The audio component 510 is configured to output and/or input audio signals. For example, the audio component 510 comprises a microphone (MIC) configured to receive an external audio signal when the device 500 is in an operation mode, such as a call mode, a recording mode, and a voice recognition mode. The received audio signal may be further stored in the memory 504 or transmitted via the communication component 516. In some embodiments, the audio component 510 further comprises a speaker to output audio signals.

The I/O interface 512 provides an interface between the processing component 502 and peripheral interface modules, such as a keyboard, a click wheel, buttons, and the like. The buttons may comprise, but are not limited to: a home button, a volume button, a starting button, and a locking button.

The sensor component 514 comprises one or more sensors to provide various aspects of status assessments for the device 500. For instance, the sensor component 514 may detect an open/closed status of the device 500, relative positioning of components, such as the display and the keypad of the device 500. The sensor component 514 may also detect a position change of the device 500 or a component thereof, a presence or absence of a contact between the user and the device 500, an orientation or acceleration/deceleration of the device 500, and a temperature change of the device 500. The sensor component 514 may comprise a proximity sensor configured to detect the presence of nearby objects without any physical contact. The sensor component 514 may further comprise a light sensor, such as a CMOS or CCD image sensor, for use in imaging applications. In some embodiments, the sensor component 514 may further comprise an accelerometer sensor, a gyroscope sensor, a magnetic sensor, a pressure sensor, a microwave sensor, and/or a temperature sensor.

The communication component 516 is configured to facilitate communication of the device 500, wired or wirelessly, with other devices. The device 500 can access a communication standard based wireless network, such as WiFi, 2G or 3G or a combination thereof. In an exemplary embodiment, the communication component 516 receives a broadcast signal from an external broadcast management system or broadcasts the associated information via a broadcast channel. In an exemplary embodiment, the communication component 516 further comprises a near field communication (NFC) module to facilitate short-range communication. For example, the NFC module may be implemented based on radio frequency identification (RFID) technique, infrared data association (IrDA) technique, ultra-wideband (UWB) technique, Bluetooth (BT) technique, and other techniques.

In some embodiments, the device 500 may be implemented with one or more circuitries, which include application specific integrated circuits (ASIC), digital signal processors (DSP), digital signal processing devices (DSPD), programmable logic devices (PLD), field programmable gate arrays (FPGA), controllers, micro-controllers, microprocessors, or other electronic components. The device 500 may use the circuitries in combination with the other hardware or software components for performing the above described methods. Each module, sub-module, unit, or sub-unit in the disclosure may be implemented at least partially using the one or more circuitries.

In one or more embodiments, there is also provided a non-transitory computer-readable storage medium including instructions, such as the memory 504 including instructions, and the instructions can be executed by the processor 520 of the device 500 to implement the above described methods. For example, the non-transitory computer-readable storage medium may be a ROM, a random access memory (RAM), a CD-ROM, a magnetic tape, a floppy disc, an optical data storage device, etc.

A non-transitory computer-readable storage medium, when the instruction in the storage medium is executed by the processor of the device 500, enables the device 500 to perform, for example, the exemplary methods depicted in FIG. 1, FIG. 2A, and FIG. 2G

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

Other embodiments of the present disclosure will be apparent to those skilled in the art from consideration of the specification and practice of the disclosure disclosed herein. The present disclosure is intended to cover any variations, uses or adaptations of the present disclosure, and these variations, uses and adaptations follow the general principles of the present disclosure and comprise common general knowledge and conventional techniques of the art which are not disclosed herein. The specification and the embodiments are merely considered as exemplary, and the true scope and spirit of the present disclosure are indicated by the following claims.

It should be appreciated that the present disclosure is not limited to the exact structures and processes that have been described above and illustrated in the accompanying drawings, and that various modifications and changes can be made without departing from the scope thereof. It is intended that the scope of the present disclosure is only limited by the appended claims.

What is claimed is:

1. A method for multi-task management implemented in a computing device, the method comprising:
receiving an operation signal for triggering display of a multi-task management interface;
identifying every application running in the background on the computing device;
acquiring, for each running application, cache pages corresponding to the running application;
displaying, in the multi-task management interface, collections of previews for applications running in the background, a collection of previews for an application being used to aggregate and display cache pages corresponding to the application;
receiving a selection of one of the cache pages in one of the collections of previews; and
acquiring the selected cache page, and controlling the application corresponding to the selected cache page to run in the foreground and initially display the selected cache page.

2. The method of claim 1, wherein the displaying collections of previews for applications comprises:
presenting, for a collection of previews for each application, cache pages related to the application in a superposition manner according to a first predetermined order;
wherein at least part of the area of any cache page in each collection of previews is not covered by other cache pages in the collection of previews.

3. The method of claim 2, further comprising:
receiving a switch signal triggered for a designated collection of previews, the switch signal indicating a swapping of which cache page is presented on a top layer; and
controlling a first cache page presented on the top layer of the designated collection of previews to switch to be presented on a bottom layer of the designated collection of previews, and switching a second cache page behind the first cache page to be presented on the top layer of the designated collection of previews.

4. The method of claim 1, wherein the displaying collections of previews for applications comprises:
presenting, for a collection of previews for each application, a predetermined number of cache pages related to the application in a superposition manner according to a second predetermined order;
wherein at least part of the area of any cache page in each collection of previews is not covered by other cache pages in the collection of previews.

5. The method of claim 1, further comprising presenting each cache page in one collection of previews in an extension way when detecting that the collection of previews is selected.

6. The method of claim 5, wherein the extension way includes presenting cache pages as tiles.

7. The method of claim 1, wherein the controlling an application corresponding to the selected cache page to run in the foreground comprises controlling the application corresponding to the selected cache page to run in the foreground if the selected cache page is on a top layer of the collection of previews in which the selected cache page is located.

8. The method of claim 1, further comprising, after acquiring a selected cache page, controlling the selected cache page to be presented on a top layer of a collection of previews in which the selected cache page is located if the selected cache page is not on the top layer of the collection of previews in which the selected cache page is located.

9. The method of claim 1, further comprising, after an application is started, caching pages that the application opens during startup, and considering the pages to be cache pages corresponding to the application.

10. The method of claim 9, further comprising clearing cache pages when the corresponding application stops running.

11. A computing device with multi-task management, the computing device comprising:
a processor; and
a memory for storing processor-executable instructions;
wherein the processor is configured to:
receive an operation signal for triggering display of a multi-task management interface;
identify every application running in the background on the computing device;
acquire, for each running application, cache pages corresponding to the running application;
display, in the multi-task management interface, collections of previews for the applications running in the background, a collection of previews for an application aggregating and displaying cache pages corresponding to the application;
receive a selection of one of the cache pages in one of the collections of previews; and
acquire the selected cache page, and control the application corresponding to the selected cache page to run in the foreground and initially display the selected cache page.

12. The device of claim 11, wherein the processor is further configured to:
present, for a collection of previews for each application, cache pages related to the application in a superposition manner according to a first predetermined order; or
present, for a collection of previews for each application, a predetermined number of cache pages related to the application in a superposition manner according to a second predetermined order;
wherein at least part of the area of any cache page in each collection of previews is not covered by other cache pages in the collection of previews.

13. The device of claim 12, wherein the processor is further configured to:
receive a switch signal triggered for a designated collection of previews, the switch signal indicating a swapping of which cache page is presented on a top layer; and
control a first cache page presented on the top layer of the designated collection of previews to switch to be presented on a bottom layer of the designated collection of previews, and switching a second cache page behind the first cache page to be presented on the top layer of the designated collection of previews.

14. The device of claim 11, wherein the processor is further configured to present each cache page in one collection of previews in an extension way when detecting that the collection of previews is selected.

15. The device of claim 14, wherein the extension way includes presenting cache pages as tiles.

16. The device of claim 11, wherein the processor is further configured to control the application corresponding to the selected cache page to run in the foreground if the selected cache page is on a top layer of the collection of previews in which the selected cache page is located.

17. The device of claim 11, wherein the processor is further configured to, after acquiring a selected cache page, control the selected cache page to be presented on a top layer of a collection of previews in which the selected cache page is located if the selected cache page is not on the top layer of the collection of previews in which the selected cache page is located.

18. The device of claim 11, wherein the processor is further configured to, after an application is started, cache pages that the application opens during startup, and consider the pages to be cache pages corresponding to the application.

19. The device of claim 18, wherein the processor is further configured to clear cache pages when the corresponding application stops running.

20. A non-transitory computer-readable storage medium having stored therein instructions that, when executed by a processor of a computing device, causes the device to perform a method applied for multi-task management, the method comprising:
receiving an operation signal for triggering display of a multi-task management interface;
identifying every application running in the background on the computing equipment;
acquiring, for each running application, cache pages corresponding to the running application;
displaying, in the multi-task management interface, collections of previews for applications running in the background, a collection of previews for an application being used to aggregate and display cache pages corresponding to the application;
receiving a selection of one of the cache pages in one of the collections of previews; and
acquiring the selected cache page, and controlling the application corresponding to the selected cache page to run in the foreground and initially display the selected cache page.
